(19) United States
(12) Patent Application Publication
(10) Pub. No.: US 2026/0128455 A1
(43) Pub. Date: May 7, 2026

(54) ENERGY STORAGE DEVICE

(71) Applicant: TOYOTA JIDOSHA KABUSHIKI KAISHA, Toyota-shi (JP)

(72) Inventors: Makoto IWATA, Toyota-shi (JP); Shotaro ISHIKAWA, Miyoshi-shi (JP); Shunsuke FUJIWARA, Toyota-shi (JP); Soichiro NAKAMURA, Toyota-shi (JP); Takahiko NAKANO, Toyota-shi (JP); Kosuke SUZUKI, Toyota-shi (JP); Masahiro ISHIZUKA, Toyota-shi (JP); Kensuke MATSUO, Seto-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/332,444

(22) Filed: Sep. 18, 2025

(30) Foreign Application Priority Data
Nov. 5, 2024 (JP) 2024-193779

(51) Int. Cl. H01M 50/342

(52) U.S. Cl. CPC H01M 50/3425; H01M 2220/20

(57) ABSTRACT

An energy storage device includes a plurality of energy storage cells, a bottom wall, and a panel member that, together with the bottom wall, defines an exhaust path. Each of the energy storage cells includes a cell case that houses an electrode assembly. A safety valve is provided on a lower surface of the cell case. The bottom wall has a through hole provided at a position facing the safety valve. The safety valve includes a rupture portion configured to rupture when the internal pressure of the cell case reaches a reference value, and a connecting portion that connects the cell case and the rupture portion. The connecting portion is deformable into a shape in which it protrudes outward from the cell case when the internal pressure of the cell case reaches the reference value.

### CROSS-REFERENCE TO RELATED APPLICATION

This application claims priority to Japanese Patent Application No. 2024-193779 filed on Nov. 5, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

For example, Japanese Unexamined Patent Application Publication No. 2023-126584 (JP 2023-126584 A) discloses a battery including a plurality of cells, a case that houses the cells, a protective member that protects a bottom portion of the case, and a cover. The protective member is fixed to the bottom portion of the case by a fastener. A relief mechanism is provided on the bottom surface of each cell. Substances discharged from the relief mechanism flow into a collection cavity formed between the bottom portion of the case and the protective member.

### SUMMARY

In the battery described in JP 2023-126584 A, there is a concern that substances discharged from the relief mechanism of one cell may adhere to another cell.

An object of the present disclosure is to provide an energy storage device capable of reducing adhesion of substances discharged from one energy storage cell to another energy storage cell.

An energy storage device according to one aspect of the present disclosure includes: a plurality of energy storage cells; a bottom wall disposed below the energy storage cells; and a panel member provided below the bottom wall and defining, together with the bottom wall, an exhaust path. Each of the energy storage cells includes a cell case that houses an electrode assembly. A safety valve is provided on a lower surface of the cell case. The bottom wall has a through hole provided at a position facing the safety valve. The safety valve includes a rupture portion configured to rupture when the internal pressure of the cell case reaches a reference value, and a connecting portion that connects the cell case and the rupture portion. The connecting portion is deformable into a shape in which the connecting portion protrudes outward from the cell case when the internal pressure of the cell case reaches the reference value.

The present disclosure can provide an energy storage device capable of reducing adhesion of substances discharged from one energy storage cell to another energy storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle equipped with an energy storage device according to an embodiment of the present disclosure;

FIG. 2 is a perspective view schematically illustrating the energy storage device;

FIG. 3 is a plan view schematically illustrating the energy storage device with an upper cover removed;

FIG. 4 is a sectional view taken along line IV-IV in FIG. 3;

FIG. 5 is a diagram schematically illustrating a safety valve;

FIG. 6 is a sectional view taken along line VI-VI in FIG. 5; and

FIG. 7 is a sectional view schematically illustrating a rupture portion in a ruptured state.

### DETAILED DESCRIPTION OF EMBODIMENTS

An embodiment of the present disclosure will be described with reference to the drawings. The same or corresponding components are denoted by the same signs throughout the drawings.

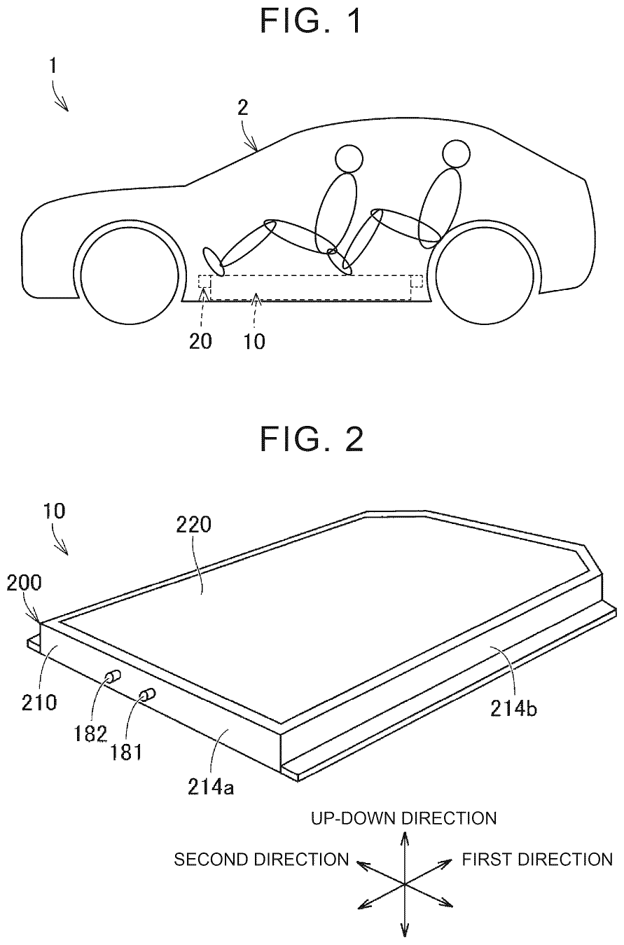

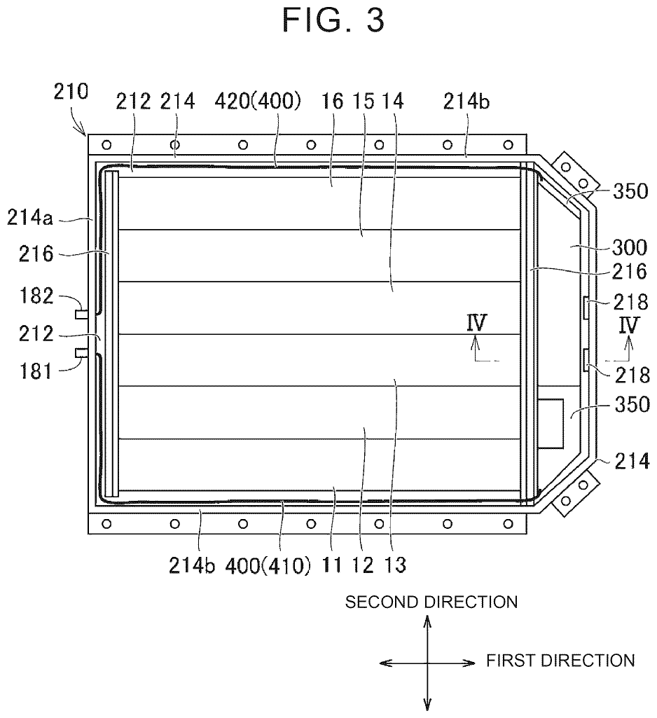

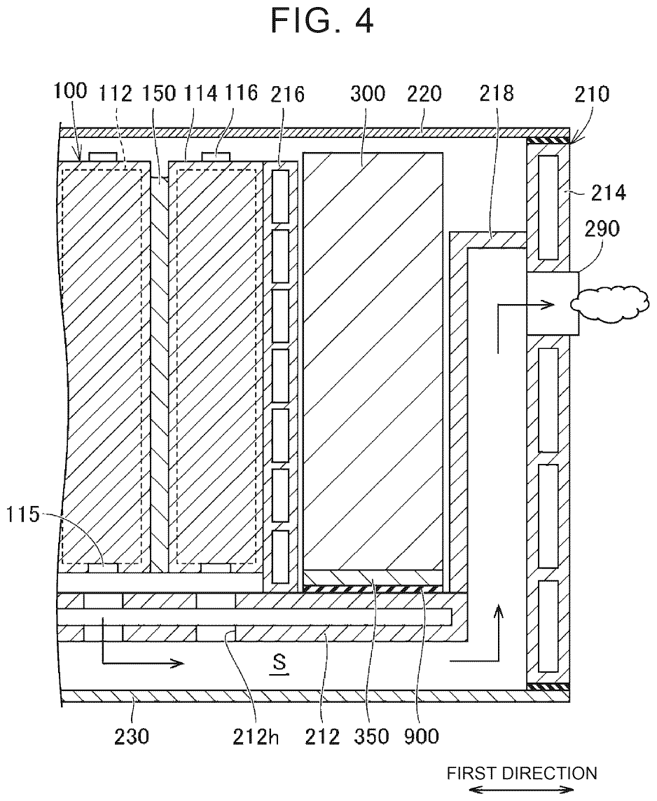

FIG. 1 is a diagram schematically illustrating a vehicle equipped with an energy storage device according to an embodiment of the present disclosure. FIG. 2 is a perspective view schematically illustrating the energy storage device. FIG. 3 is a plan view schematically illustrating the energy storage device with an upper cover removed. FIG. 4 is a sectional view taken along line IV-IV in FIG. 3.

As shown in FIG. 1, a vehicle 1 includes a vehicle body 2 and an energy storage device 10. The vehicle 1 may be, for example, a hybrid electric vehicle, a plug-in hybrid electric vehicle, or a battery electric vehicle.

As shown in FIGS. 1 and 2, the vehicle body 2 includes a frame member 20. The frame member 20 is disposed at the bottom of the vehicle body 2. The frame member 20 is formed in a substantially rectangular tubular shape that surrounds the energy storage device 10.

The energy storage device 10 is mounted to the frame member 20. As shown in FIGS. 1 to 4, the energy storage device 10 includes six energy storage stacks 11 to 16, a housing 200, devices 300, a device cooler 350, and a cooling medium pipe 400. The number of energy storage stacks is not limited to six.

Each of the energy storage stacks 11 to 16 is formed in a rectangular parallelepiped shape elongated in a first direction. As shown in FIG. 3, the six energy storage stacks 11 to 16 are arranged side by side along a second direction that is perpendicular to both the first direction and an up-down direction. In the present embodiment, the first direction corresponds to the front-rear direction of the vehicle, and the second direction corresponds to the left-right direction (width direction) of the vehicle. Each of the energy storage stacks 11 to 16 includes at least one energy storage cell 100. In the present embodiment, each of the energy storage stacks 11 to 16 includes a plurality of energy storage cells 100 and a plurality of cooling plates 150.

The energy storage cells 100 are arranged side by side along the first direction. As shown in FIG. 4, each energy storage cell 100 includes an electrode assembly 112, a cell case 114, and a pair of external terminals 116.

The electrode assembly 112 may be configured as a wound body in which a cathode sheet and an anode sheet are wound with a separator interposed therebetween, or as a stacked body in which a cathode sheet and an anode sheet are stacked with a separator interposed therebetween. The electrode assembly 112 is formed in an elongated shape along the second direction.

The cell case 114 houses the electrode assembly 112. The cell case 114 is formed in a rectangular parallelepiped shape. The cell case 114 is made of a metal such as aluminum. A safety valve 115 is provided on a lower surface of the cell case 114. The safety valve 115 will be described in detail later.

The external terminals 116 are provided on an upper surface of the cell case 114. The external terminals 116 are provided at positions spaced apart from each other in the width direction of the cell case 114. The width direction of the cell case 114 corresponds to the second direction.

As shown in FIG. 4, each cooling plate 150 is disposed between a corresponding pair of energy storage cells 100 adjacent to each other in the first direction. Each cooling plate 150 is formed in a flat plate shape elongated in the second direction. Each cooling plate 150 has a flow path (not shown) for a cooling medium along the second direction.

The housing 200 houses the six energy storage stacks 11 to 16. As shown in FIGS. 2 to 4, the housing 200 includes a lower case 210, an upper cover 220, and a panel member 230.

The lower case 210 is open at the top. The lower case 210 may be made of a metal such as aluminum. The lower case 210 includes a bottom wall 212, a peripheral wall 214, and a pair of partition walls 216.

The bottom wall 212 is located below the energy storage stacks 11 to 16. In the present embodiment, the bottom wall 212 is formed as a hollow structure. The bottom wall 212 may be formed by extrusion molding. However, the bottom wall 212 may instead be formed as a solid flat plate. As shown in FIG. 4, a plurality of through holes 212h is formed in the bottom wall 212. Each through hole 212h is provided at a position facing a corresponding safety valve 115.

A plurality of heat insulating members (not shown) may be provided on the bottom wall 212. Each heat insulating member is shaped so as to cover a corresponding through hole 212h. Each heat insulating member serves to protect a corresponding energy storage cell 100 from gas discharged from a corresponding safety valve 115. Each heat insulating member is made of, for example, mica obtained by hot pressing a natural inorganic mineral.

The peripheral wall 214 stands from the peripheral edge of the bottom wall 212. The peripheral wall 214 is shaped to surround the energy storage stacks 11 to 16. The peripheral wall 214 may be formed as a hollow structure. The peripheral wall 214 includes a front wall 214a and a pair of side walls 214b.

The front wall 214a is formed on one side (left side in FIG. 3) of the energy storage stacks 11 to 16 in the first direction. The front wall 214a extends in the second direction. In the present embodiment, the one side in the first direction corresponds to the front side in the front-rear direction of the vehicle.

The side walls 214b are spaced apart from each other and face each other in the second direction. Each side wall 214b extends in the first direction. An end of each side wall 214b located on the one side in the first direction (i.e., the front end of each side wall 214b) is connected to the front wall 214a.

The partition walls 216 divide the space surrounded by the bottom wall 212 and the peripheral wall 214 into a space in which the energy storage stacks 11 to 16 are disposed, and another space. The partition walls 216 are spaced apart from each other in the first direction. Each partition wall 216 extends in the second direction. Each partition wall 216 may be formed as a hollow structure. The partition walls 216 serve to restrain the energy storage stacks 11 to 16 from both sides in the first direction. As shown in FIG. 3, one of the partition walls 216 is formed on the one side in the first direction (i.e., the front side), and each end of this partition wall 216 in the second direction is spaced apart from a corresponding side wall 214b. The other partition wall 216 is formed on the other side in the first direction (i.e., the rear side), and each end of this partition wall 216 in the second direction is connected to a corresponding side wall 214b.

The upper cover 220 is disposed above the energy storage stacks 11 to 16. The upper cover 220, together with the lower case 210, houses the six energy storage stacks 11 to 16. Specifically, the upper cover 220, together with the lower case 210, houses the six energy storage stacks 11 to 16 in a sealed state. The peripheral edge of the upper cover 220 is connected to the upper end of the peripheral wall 214 via a sealing member by bolts etc.

The panel member 230 is provided below the lower case 210. The panel member 230 serves to protect the bottom wall 212 of the lower case 210. The panel member 230 may be formed in a flat plate shape. The peripheral edge of the panel member 230 is connected to a lower surface of the lower case 210 via a sealing member.

As shown in FIG. 4, a space S is formed between the panel member 230 and the bottom wall 212. Each space S serves as an exhaust path (hereinafter referred to as “exhaust path S”). The exhaust path S is a path for guiding gas discharged from the safety valves 115 of the energy storage cells 100 to the outside of the housing 200.

As shown in FIGS. 3 and 4, an exhaust duct 218 is formed on the peripheral wall 214. The exhaust duct 218 extends upward from the bottom wall 212. The exhaust duct 218 guides the gas upward from the exhaust path S. A relief valve 290 is provided at the downstream end of the exhaust duct 218. The relief valve 290 relieves pressure inside the housing 200. The relief valve 290 opens when the pressure inside the housing 200 reaches or exceeds a reference value. The relief valve 290 is configured as a check valve. As shown in FIG. 4, when gas is discharged from any of the energy storage cells 100, the gas spreads in the first direction through the exhaust path S and is discharged to the outside of the housing 200 via the exhaust duct 218 and the relief valve 290.

The devices 300 are housed in the housing 200. As shown in FIG. 3, the devices 300 are disposed in a space formed between the peripheral wall 214 and the partition wall 216 formed on the other side of the lower case 210 in the first direction, namely on the other in the first direction (i.e., the rear side). The devices 300 may include a junction box. The devices 300 may further include a relay, a control device, or the like.

The device cooler 350 cools the devices 300. As shown in FIGS. 3 and 4, the device cooler 350 is provided between the bottom wall 212 and the devices 300. A thermally conductive adhesive 900 may be provided between the device cooler 350 and the bottom wall 212.

The cooling medium pipe 400 is routed inside the housing 200. The cooling medium pipe 400 is connected to each cooling plate 150 and the device cooler 350. As shown in FIGS. 2 and 3, the front wall 214a of the peripheral wall 214 is provided with an inlet port 181 and an outlet port 182. The cooling medium pipe 400 is connected to the inlet port 181 and the outlet port 182. Accordingly, the cooling medium (e.g., water or oil) supplied from the inlet port 181 flows into each cooling plate 150 and the device cooler 350 through the cooling medium pipe 400, cools the energy storage cells 100 and the devices 300, and then flows out from the outlet port 182 through the cooling medium pipe 400.

As shown in FIG. 3, the cooling medium pipe 400 includes an upstream pipe 410 and a downstream pipe 420.

The upstream end of the upstream pipe 410 is connected to the inlet port 181. The downstream end of the upstream pipe 410 is connected to one end of the device cooler 350 in the second direction. The upstream pipe 410 is routed so as to pass between the front wall 214a and the partition wall 216 formed on the one side in the first direction, and between the side wall 214b and the energy storage stack 11 disposed on one side in the second direction. The upstream pipe 410 is connected to one end of each cooling plate 150 in the second direction.

The upstream end of the downstream pipe 420 is connected to the other end of the device cooler 350 in the second direction. The downstream end of the downstream pipe 420 is connected to the outlet port 182. The downstream pipe 420 is routed so as to pass between the front wall 214a and the partition wall 216 formed on the one side in the first direction, and between the side wall 214b and the energy storage stack 16 disposed on the other side in the second direction. The downstream pipe 420 is connected to the other end of each cooling plate 150 in the second direction.

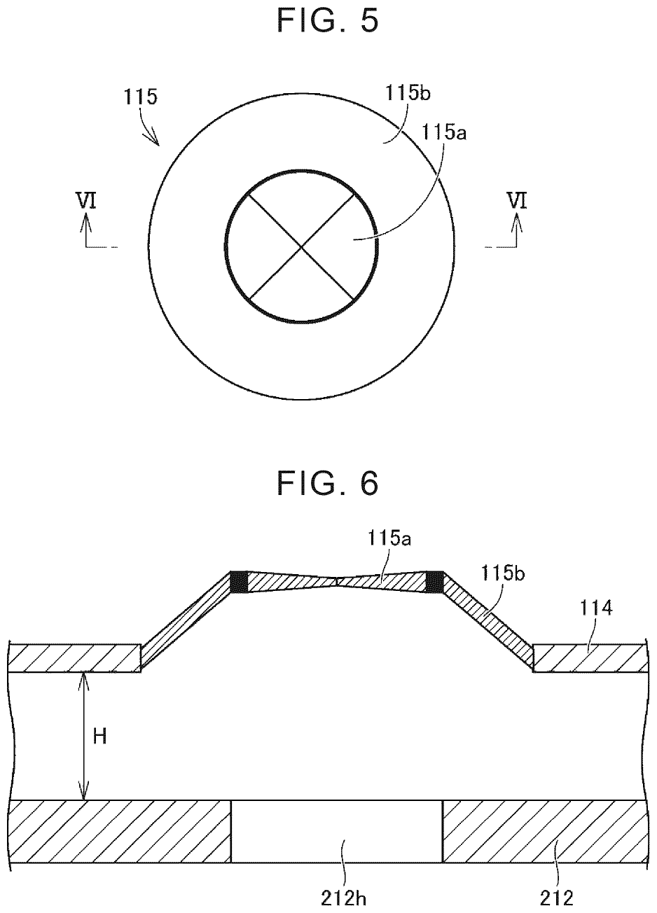

Next, the safety valve 115 will be described in detail with reference to FIGS. 5 to 7. The safety valve 115 includes a rupture portion 115a and a connecting portion 115b.

The rupture portion 115a ruptures when the internal pressure of the cell case 114 reaches a reference value. The rupture portion 115a may be formed in a circular shape when viewed from below. A rupture-inducing portion (reduced thickness portion) is formed in the rupture portion 115a.

The connecting portion 115b connects the cell case 114 and the rupture portion 115a. The connecting portion 115b surrounds the rupture portion 115a in an annular shape. The rupture portion 115a gradually decreases in thickness from the connecting portion 115b toward the center of the rupture portion 115a.

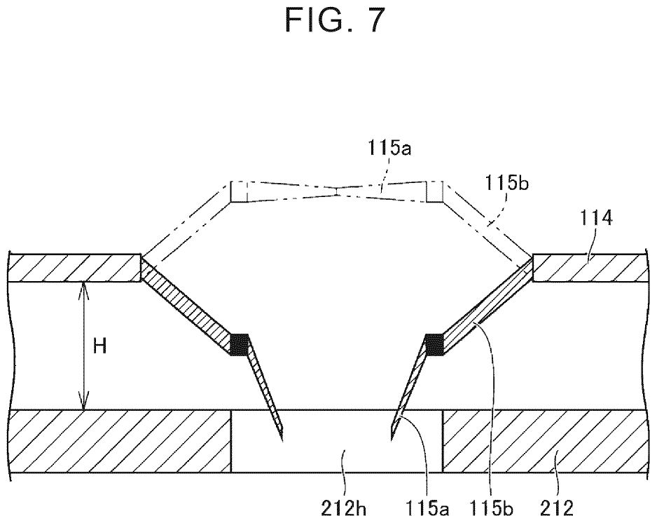

As shown in FIG. 6, the connecting portion 115b has a shape recessed toward the inside of the cell case 114, when the internal pressure of the cell case 114 is less than the reference value. As shown in FIG. 7, the connecting portion 115b is deformable into a shape in which it protrudes outward (downward in the present embodiment) from the cell case 114, when the internal pressure of the cell case 114 reaches the reference value. The distance H between the lower surface of the cell case 114 and the upper surface of the bottom wall 212 is set to such a length that the lower end of the rupture portion 115a is located within the through hole 212h when the rupture portion 115a ruptures.

In the energy storage device 10 described above, when the internal pressure of the cell case 114 of any of the energy storage cells 100 reaches the reference value due to a short circuit or the like, the connecting portion 115b protrudes toward the bottom wall 212. Therefore, the distance between the rupture portion 115a of the safety valve 115 and the bottom wall 212 is reduced. Moreover, as shown in FIG. 7, when the rupture portion 115a ruptures, the lower end of the rupture portion 115a is located within the through hole 212h. Accordingly, substances discharged from the energy storage cell 100 through the rupture portion 115a effectively flow into the exhaust path S. This configuration reduces scattering of the discharged substances toward the energy storage cell 100 or adhesion of the discharged substances to another energy storage cell.

The gas contained in the discharged substances that have flowed into the exhaust path S from the safety valve 115 spreads through the exhaust path S and is discharged from the housing 200 through the relief valve 290, as shown in FIG. 4. This configuration reduces adhesion of the contents of the energy storage cell 100 (i.e., so-called debris) contained in the discharged substances to the external terminals 116 or the like of the energy storage cell 100.

Note that the distance H between the lower surface of the cell case 114 and the upper surface of the bottom wall 212 may be set to such a length that the lower end of the rupture portion 115a is located above the through hole 212h when the rupture portion 115a ruptures.

It will be understood by those skilled in the art that the exemplary embodiment described above is a specific example of the following aspects.

### First Aspect

An energy storage device including:
a plurality of energy storage cells;
a bottom wall disposed below the energy storage cells; and
a panel member provided below the bottom wall and defining, together with the bottom wall, an exhaust path, wherein:
   each of the energy storage cells includes a cell case that houses an electrode assembly;
   a safety valve is provided on a lower surface of the cell case;
   the bottom wall has a through hole provided at a position facing the safety valve; the safety valve includes
      a rupture portion configured to rupture when an internal pressure of the cell case reaches a reference value, and
      a connecting portion that connects the cell case and the rupture portion; and
   the connecting portion is deformable into a shape in which it protrudes outward from the cell case when the internal pressure of the cell case reaches the reference value.

In this energy storage device, when the internal pressure of the cell case of one energy storage cell reaches the reference value, the connecting portion protrudes toward the bottom wall. As a result, the distance between the rupture portion of the safety valve and the bottom wall is reduced. Accordingly, substances discharged from the energy storage cell through the rupture portion effectively flow into the exhaust path. This configuration reduces scattering of the substances discharged from one energy storage cell toward another energy storage cell or adhesion of such substances to another energy storage cell.

### Second Aspect

The energy storage device according to the first aspect, wherein the connecting portion has a shape recessed toward the inside of the cell case when the internal pressure of the cell case is less than the reference value.

### Third Aspect

The energy storage device according to the first or second aspect, wherein the rupture portion gradually decreases in thickness from the connecting portion toward the center of the rupture portion.

In this aspect, the rupture portion ruptures effectively.

### Fourth Aspect

The energy storage device according to any one of the first to third aspects, wherein the distance between the lower surface of the cell case and an upper surface of the bottom wall is set to such a length that a lower end of the rupture portion is located within the through hole when the rupture portion ruptures.

In this aspect, substances discharged from the energy storage cell through the rupture portion more reliably flow into the exhaust path.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. An energy storage device comprising:
a plurality of energy storage cells;
a bottom wall disposed below the energy storage cells; and
a panel member provided below the bottom wall and defining, together with the bottom wall, an exhaust path, wherein:
each of the energy storage cells includes a cell case that houses an electrode assembly;
a safety valve is provided on a lower surface of the cell case;
the bottom wall has a through hole provided at a position facing the safety valve;
the safety valve includes
a rupture portion configured to rupture when an internal pressure of the cell case reaches a reference value, and
a connecting portion that connects the cell case and the rupture portion; and
the connecting portion is deformable into a shape in which the connecting portion protrudes outward from the cell case when the internal pressure of the cell case reaches the reference value.

2. The energy storage device according to claim 1, wherein the connecting portion has a shape recessed toward inside of the cell case when the internal pressure of the cell case is less than the reference value.

3. The energy storage device according to claim 1, wherein the rupture portion gradually decreases in thickness from the connecting portion toward a center of the rupture portion.

4. The energy storage device according to claim 1, wherein a distance between the lower surface of the cell case and an upper surface of the bottom wall is set to such a length that a lower end of the rupture portion is located within the through hole when the rupture portion ruptures.
